(19) United States
(12) Patent Application Publication
(10) Pub. No.: US 2015/0260226 A1
(43) Pub. Date: Sep. 17, 2015

(54) ROLLING BEARING CAGE AND METHOD FOR MANUFACTURING

(71) Applicant: AKtiebolaget SKF, Göteborg (SE)

(72) Inventor: Hans Lindèn, Ytterby (SE)

(21) Appl. No.: 14/425,269

(22) PCT Filed: Aug. 19, 2013
(86) PCT No.: PCT/SE2013/000124

§ 371 Date: Mar. 2, 2015

(30) Foreign Application Priority Data
Aug. 31, 2012 (SE) 1200524-5

(51) Int. Cl. F16C 33/46; B23P 15/00; F16C 33/54

(52) U.S. Cl. CPC F16C 33/4676; F16C 33/548; B23P 15/003

(57) ABSTRACT

The present invention relates to a rolling bearing cage for controlling the position of rolling elements between an inner and an outer raceway in a rolling bearing. The rolling bearing cage includes a cage body having a circular first rim portion, a plurality of rib portions extending from the first rim portion, and a plurality of windows formed between adjacent spaced apart rib portions for receiving and rolling elements, wherein the first rim portion and the plurality of rib portions of the cage body is formed of a one-piece sheet material and is provided with an undulating structure. The present invention also relates to a method for manufacturing a rolling bearing cage.

### FIELD OF THE INVENTION

The present invention relates to rolling bearings and rolling bearing components, and more specifically to a rolling bearing cage for controlling the position of rolling elements between an inner and an outer raceway in a rolling bearing. The present invention also relates to a method for manufacturing a rolling bearing cage.

The rolling bearing cage may for example by used for controlling the position of the rolling elements in the a roller bearing or ball bearing, or equivalent, wherein the orientation of rolling elements may controlled in relation to each other and in relation to the raceways of the rolling bearing.

### BACKGROUND ART

In order to separate and control the position of rolling elements of rolling element bearing, it is known to provide a bearing cage. The bearing cage prevents the rolling elements, such as balls, rollers, or tapered rollers, from rubbing against each other, and guides the rolling elements in relation to the rolling bearing raceways in a suitable manner.

In the art, it is known to make use of bearing cages made of sheet metal. For example, in U.S. Pat. No. 5,152,615, a rolling element bearing assembly including a cage made of a bent strip of sheet metal having abutting ends connected to one another is described, which cage comprises two end rings and cage frame surrounding a plurality of windows retaining rolling elements. The added weight to the bearing assembly from the cage, however, increases the overall weight and moment of inertia of the rotating components of the assembly. The cage also impedes the performance of the bearing and increase the cost for handling and manufacturing. Hence, there is a need for providing improved rolling element bearing cages allowing for improved performance and efficient manufacturing.

### SUMMARY OF THE INVENTION

In view of the above-mentioned and other drawbacks of the prior art, a general object of the present invention is to provide an improved and more efficient rolling bearing cage for rolling elements in a rolling element bearing.

These and other objects are achieved by a rolling element cage and a method for manufacturing a rolling bearing cage according to the independent claims. Preferred embodiments of the invention are presented in the dependent claims.

According to a first aspect thereof, the present invention relates to a rolling bearing cage for controlling the position of rolling elements between an inner and an outer raceway in a rolling bearing. The rolling bearing cage comprises a cage body comprising a circular first rim portion, a plurality of rib portions extending from the first rim portion in a circumferentially spaced apart configuration in relation to each other, and a plurality of windows formed between adjacent spaced apart rib portions for receiving and controlling the position of the rolling elements, wherein the first rim portion and the plurality of rib portions of the cage body is formed of a one-piece sheet material and is provided with an undulating structure.

The present invention is based on the realization that improved structural strength of the rolling bearing cage is provided due to the undulating, or corrugated, structure which allows for increased stiffness of the cage body in relation to the thickness of the sheet material of which it is formed. Thereby, the thickness and weight of the cage body may be reduced, which, in turn, reduces its moments of inertia leading to improved and more efficient rolling bearings.

The undulating structure of the sheet material of which the cage body is formed further increases the overall surface area of the cage body. For example, by increasing the surface area, there is an increased area for holding and storing lubricant, such as grease or oil. In particular, the undulating structure forms a lubrication reservoirs holding an increased amount of lubricant which can dissipate to the rolling elements and raceway of a rolling bearing during a longer time period, thereby increasing the lift time and/or reducing the time to service of a bearing arrangement provided with the rolling bearing cage according to the present invention. Also, the need for and requirements of auxiliary lubrications systems may be reduced or avoided, which leads to cost reductions and reduced space requirements.

A further advantage is that the cage body may be manufactured in an efficient and improved manner from a workpiece formed of thinner and lighter sheet material. In particular, handling and manufacturing is considerably improved and may be performed in a more cost efficient manner. For example, the cage body may be formed in manufacturing process involving pressure turning, or metal spinning, or flow forming of sheet metal workpiece, such as a thin sheet metal disc, using e.g. a CNC lathe and one or more tool turrets equipped with metal working tools. The cage body may also be efficiently manufactured using roll forming techniques, such as a continuous bending operation in which a sheet-formed workpiece is passed through sets of rolls mounted on consecutive stands, wherein each set of rolls e.g. performs an incremental bending operation, until the desired cross-section profile of the cage body with undulating structure is obtained. Hence, the rolling bearing cage may advantageously be manufactured from workpiece to product in one manufacturing process line using manufacturing techniques with low scrapes rates and low tool costs, while allowing for high production rates, high precision, and low material costs.

The increased structural stability of the cage body provided by the undulating structure may further allow for dampening of vibrations occurring during dynamic, often cyclic, operation in a rolling bearing. For example, the direction and/or dimension, such as the width or period length of the undulating structure, may be adapted to reduce certain vibrations having certain frequencies or frequency intervals associated with particular operating conditions, such as certain rotational speeds or dynamic loads, of a rolling bearing. The undulating structure further allows for reduction of fatigue and noise problems associated with the operating of rolling bearing provided with the rolling bearing cage according to the present invention.

For example, the dimensions of the windows are arranged to fit the intended rolling elements. The dimension of the windows formed between the rib portions may further be arranged to secure the rolling elements by snap-acting locking, wherein the rib portions are arranged to receive a rolling element while at least partially flexing away from each in order to allow for insertion of a rolling element therebetween. Thereby, securing of the rolling elements may be further improved. Furthermore, the structural strength provided by the undulating structure may be arranged and aligned to strengthen the flexing and/or snap-acting locking function of the cage body.

The rolling bearing cage may for example be used for keeping the rolling elements evenly distributed around the complete circumference to provide even load distribution and quiet and uniform running, wherein the rib portions are arranged tangentially between the rolling elements, for guiding the rolling elements in the unloaded zone to improve the rolling conditions in the bearing and to prevent damaging sliding movements, and/or for retaining the rolling elements, where bearings are of a separable design and one bearing ring is removed during mounting or dismounting.

According to an exemplifying embodiment of the rolling bearing cage, the undulating structure has a wavelike shape comprising a plurality of consecutively repeating sections. For example, the wavelike shape of the undulating structure is formed of repeating sections having a sine waveform shape, a square waveform shape, a triangular waveform shape, a saw tooth waveform shape, or a combination of these waveforms.

According to an exemplifying embodiment, the rolling bearing cage further comprises a circular second rim portion being coaxial with the first rim portion, wherein each one of the plurality of rib portions extends from the first rim portion to the second rim portion. Thereby, each window for receiving the roller elements is delimited by the first and second rim portions and a pair of rib portion extending between the first and second rim portion in a parallel, substantially parallel, or in a unidirectional configuration to each other in relation to a center point. According to an exemplifying embodiment, also the second rim portion is provided with the undulating structure.

According to an exemplifying embodiment, the undulating structure extends across a portion of the first rim portion, across the each one of the plurality of rib portions, and across a portion of the second rim portion. For example, the undulating structure extends continuously from the first rim portion, across the plurality of rib portions, to the second rim portion.

According to an exemplifying embodiment, the undulating structure extends, partially or completely, circumferentially around the cage in a tangential direction of the circular first rim portion. In other words, the direction of extension of the undulating structure encircles the center axis of the bearing body, wherein the direction of extension of the undulating structure is orthogonal to the direction of extension of the recesses in the surface of the cage body which recesses forms the undulating structure, in analogy with the forward direction of a traveling wave front.

According to an exemplifying embodiment, the undulating structure extends circumferentially around the cage in an axial and/or radial direction of the circular first rim portion.

Moreover, according to an exemplifying embodiment, the undulating structure of the cage body is uniform. For example, the undulating structure has substantially the same periodic length of the wavelike shape of the undulating structure, or the same distance between the apexes, or ridges, of the undulating structure over the whole undulating structure or at a given radial distance from the axis of the circular first rim portion.

According to an exemplifying embodiment, the sheet material is formed of sheet metal or sheet steel. For example, according to exemplifying embodiments, the sheet metal or sheet steel has a thickness between 0.5 and 5 mm, or between 1 and 3 mm.

According to an exemplifying embodiment, the undulating structure is integrally formed in the sheet metal/steel and/or extends through its complete thickness/cross section.

For example, the main part of the cage body is provided with the undulating structure, such as at least 50%, or 75% or 90%, or 95%, of the cage body, or the complete cage body.

According to an exemplifying embodiment, the period length of the undulating structure is 1-50% of the longitudinal length extension of the rib portions. In other words, the undulating structure has a repeating shape of sections having a period length which repeats in regular intervals, wherein the periodic length of the sections corresponds to a length between 1% and 50% of the length of any one of the rib portions. Thereby, each rib portions comprises at least two, or more, complete repeating sections of the undulating structure. The period length of the undulating structure may further be 3%-50%, or 5%-35%, of the longitudinal length extension of the rib portions.

According to a further embodiment of the present invention, it relates to a rolling bearing, such as roller bearing or ball bearing, comprising a rolling bearing cage according to any one of the preceding embodiments, which rolling bearing comprises a plurality of rolling elements arranged in a row between an inner raceway of an inner ring and an outer raceway of an outer ring, wherein the cage is arranged between the inner raceway and outer raceway, and each one of the plurality of rolling elements are arranged in one of the windows in the cage body. Furthermore, according to an embodiment, lubricant, such as grease or oil, is arranged in the undulating structure. In more detail, the lubricant may be arranged in the plurality of recesses extending inwardly into the cage body, which recesses form part of the undulating structure. For example, the lubricant may be provided in, or only provided in, the recesses in the surface of the cage body facing the inner ring or in the recesses in the surface of the cage body facing the outer ring, or both surfaces.

According to a further aspect thereof, the present invention relates to a method for manufacturing a rolling bearing cage for controlling the position of rolling elements in a rolling bearing, comprising forming a cage body comprising a circular rim portion and a plurality of rib portions extending from the first rim portion in a circumferentially spaced apart configuration in relation to each other, such that a plurality of windows for receiving the rolling elements are formed between adjacent spaced apart rib portions, wherein the method further comprises forming the first rim portion and the plurality of rib portions of the cage body from a workpiece formed of a sheet material, and providing the first rim portion and the plurality of rib portions of the cage body with an undulating structure. The method is advantageous in that an improved bearing cage is provided having improved properties and which may be manufactured in an efficient and cost efficient manner. The method is also advantageous in a similar manner as described in relation to the first aspect of the invention and embodiments thereof. For example, the method involves providing the workpiece with the undulating structure in a prior step, and providing the windows and rib portions in the workpiece in a later step. Alternatively, the workpiece is provided with the windows and rib portions in a prior step and the undulating structure in a later step, or substantially simultaneously.

According to an exemplifying embodiment of the method, it comprises forming a circular second rim portion of the cage body being coaxial with the first rim portions, and providing the second rim portion with the undulating structure.

Furthermore, according to an exemplifying embodiment, the steps of forming the cage body and providing the undulating structure comprise rotating the workpiece and forming the workpiece with a first tool by exerting the first tool on the rotating workpiece according to a predetermined pattern, such as a predetermined pattern defined numerically and which is implementable in a computer numerical control (CNC) machine. For example, the workpiece, such as a circular blank or disc-shape sheet metal workpiece, may be worked by a motion controlled tool turret, equipped with a tool, against a rotating form comprising the undulating structure, wherein the tool is used to shape the rotating workpiece to the rotating form in incremental steps. Also the contacting surface of the tool, such as a roller, may be provided with the undulating structure in order to imprint or emboss the undulating structure in the workpiece during manufacturing. The disc-shaped rotating workpiece may also be shaped between by two or a plurality of motion controlled tool turrets equipped with respective tools, such as rollers, wherein the workpiece is arranged to rotated between the tools while the tools are controlled to cooperatively move to form the undulating structure in the workpiece.

According to an optional or alternative exemplifying embodiment, the steps of forming the cage body and providing the undulating structure comprise passing the workpiece against, or passed, at least one roller arranged to provide the workpiece with the undulating structure. Optionally or alternatively, the workpiece may be passed through consecutive sets of rollers, wherein each set of rollers performs an incremental bending operation of the workpiece according to a predetermined pattern. Thereby, the cage body may advantageously be formed using roll forming techniques. For example, the roller or sets of rollers are arranged to imprint or emboss the undulating structure in to the workpiece. Optionally or alternatively, the contacting surfaces of each roller is provided with a ridges and grooves corresponding to the undulating structure, which ridges and grooves are arranged to imprint the undulating structure into the workpiece during the step of forming the cage body.

According the an embodiment, the cage body is formed of a workpiece formed of flat metal strip piece, or a metal strip arranged on a continuous roll of metal, which is fed into a roll forming arrangement comprising a roller or a line of consecutive rollers arranged to form the metal strip with the undulating structure. For example, a first set of rollers provide an incremental bending step and a final set of rollers provide a final bending step. Also, intermediary set of rollers may be arranged between the first and final set of roller for provided further incremental bending steps prior to the final bending step of the final roller set.

Flow forming and/or roll forming manufacturing of the cage body may advantageously involve a workpiece of high strength steel, or high strength stainless steel, since those manufacturing processes constitute gentle forming processes e.g. involving incremental bending operations.

According to an exemplifying embodiment, the windows in the cage body are formed by providing circumferentially spaced apart openings in the workpiece. For example, the step of providing the openings may advantageously be integrated in the manufacturing process e.g. in an in-line manufacturing process, such as pressure turning, metal spinning, or flow forming manufacturing of a sheet metal workpiece, or a roll forming manufacturing process. The openings in the workpiece may for example be provided by punching/blanking techniques, using e.g. a punch and a die. According to various embodiments, the step of providing the spaced apart openings may be performed prior to or after the step of providing the cage body with a circular shape, and/or prior to or after the step of providing the undulating structure.

Generally, other objectives, features, and advantages of the present invention will appear from the following detailed disclosure, from the attached dependent claims as well as from the drawings are equally possible within the scope of the invention.

### BRIEF DESCRIPTION OF DRAWINGS

Embodiments of the invention will now be described, by way of example, with reference to the accompanying drawings, wherein:

FIG. 1 is a schematic perspective view of an exemplifying first embodiment of the rolling bearing cage according to the present invention.

FIG. 2 is a schematic perspective view of an exemplifying second embodiment of the rolling bearing cage according to the present invention.

FIG. 3 is a zoomed-in cross-sectional view of the undulating structure of the first embodiment of the rolling bearing cage according to the present invention.

FIG. 4 is a zoomed-in view of the undulating structure of the second embodiment of the rolling bearing cage according to the present invention.

FIG. 5 is a schematic perspective view of the first embodiment of the rolling bearing cage according to the present invention, prior to the provision of windows for receiving and controlling the position of the rolling elements.

FIG. 6 is a schematic perspective view of the second embodiment of the rolling bearing cage according to the present invention, prior to the provision of windows for receiving and controlling the position of the rolling elements.

FIG. 7 is a schematic cross-sectional view of an exemplifying third embodiment of the rolling bearing cage according to the present invention, wherein the rolling bearing cage is mounted in a rolling bearing.

FIG. 8 is a schematic view of an exemplifying flow forming arrangement for manufacturing the cage body of the rolling bearing cage according to the present invention.

FIG. 9 is a schematic view of an exemplifying roll forming arrangement for manufacturing the cage body of the rolling bearing cage according to the present invention.

FIG. 10, are schematic perspective views of workpieces for forming embodiments of the cage body of the rolling bearing cage according to the present invention.

FIG. 11 is a schematic view of an exemplifying roll forming arrangement 110 for manufacturing the cage body of an embodiment of the rolling bearing cage according to the present invention.

It should be understood that the drawings are not true to scale and, as is readily appreciated by a person skilled in the art, dimensions other than those illustrated in the drawings are equally possible within the scope of the invention.

### DETAILED DESCRIPTION OF EMBODIMENTS OF THE INVENTION

In the drawings, similar, or equal elements are referred to by equal reference numerals.

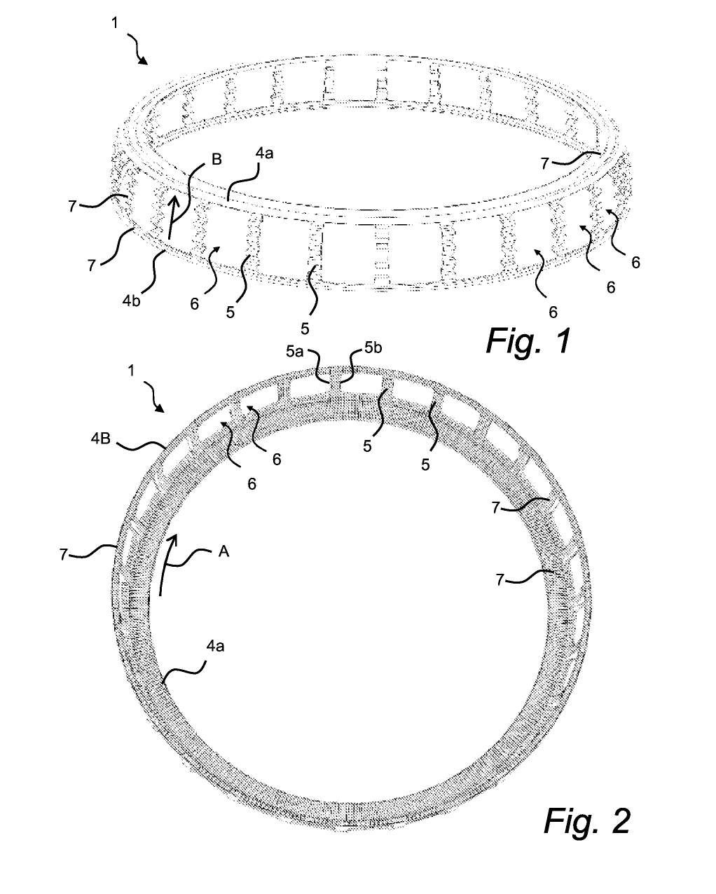

In FIG. 1, a schematic perspective view of an exemplifying first embodiment of the rolling bearing cage 1 is shown, which is arranged to be mounted in a rolling bearing for controlling the position of rolling elements between an inner and an outer raceway in a rolling bearing.

As illustrated, the rolling bearing cage 1 is formed of a circular cage body having coaxial first and second circular rim portions 4a and 4b. The cage body of the cage 1 further comprises a plurality of rib portions 5 which are arranged in a circumferentially spaced apart configuration in relation to each other, wherein each one of the rib portions 5 extends between the first and second rim portions 4a and 4b. As further shown, the rolling bearing cage 1 comprises a plurality of windows, or openings, 6 which are formed between adjacent spaced apart rib portions 5. Each window 6 is adapted to receive and control the position of a rolling element of a rolling bearing and may further be adapted to the shape of the rolling element. In the shown embodiment, the windows 6 are substantially rectangular and symmetric. However, the windows 6 may also be adapted to rolling elements having different shapes. For example, the windows 6 may be provided with curved shapes with curved rib portions 5 corresponding to rolling elements having curved shapes, such as symmetrical or non-symmetrical roller elements, e.g. barrel-shaped or tapered rollers. The cage body may also comprise a second set of rib portions extending from the first rim portion forming a second row of windows being axially and/or radially separated from the first row of windows for controlling the position of a second row for rolling elements in a double row rolling bearing.

As further shown in FIG. 1, the cage body of the rolling bearing cage 1 is provided with an undulating, or corrugated, structure 7. In more detail, the undulating, or corrugated, structure is integrally formed in the one-piece sheet material of which the cage body of the rolling bearing cage 1 is formed, for example by bending the workpiece or by imprinting and/or embossing the undulating structure into the workpiece forming the rolling bearing cage 1, such that a plurality of ridges and grooves, forming the undulating structure, are formed in the workpiece.

As shown, the undulating structure 7 encircles the cage body and is provided in the cage body around its complete circular shape. As further shown, the undulating structure 7 is provided on the second rim portion 4b and extends into and across each one of the rib portions 5 into the first rim portion 4b. Furthermore, the undulating structure 7 is symmetric and has an axis of symmetry which coincides with a center axis of the cage body and is oriented and extends circumferentially around the cage in a combined axial and radial direction indicated by B. In other words, the orientation of the wavelike shape forming the undulating structure 7 is directed in a direction B having both an axial component and a radial component, in relation to the geometry of the cage 1. However, depending on the design and geometry of the rolling bearing cage 1 and the rolling bearing it is adapted for, the wavelike shape of the undulating structure 7 may be directed mainly, or only, in the radial direction, or mainly, or only, in the axial direction.

In FIG. 2, a schematic perspective view of a second exemplifying embodiment of the rolling bearing cage 1 is shown, which is arranged according to the description of the first embodiment described in relation to FIG. 1, if not stated or illustrated otherwise. In particular, the second embodiment of the rolling bearing cage 1 in FIG. 2 differs from the first embodiment of the rolling bearing cage in that the ridges and grooves of the undulating, or corrugated, structure 7 is oriented differently. As illustrated, the undulating structure 7 is symmetric and is oriented and extends circumferentially around the cage in a tangential direction of the cage body indicated by A. However, depending on the design and geometry of the rolling bearing cage 1 and the rolling bearing it is adapted for, the wavelike shape of the undulating structure 7 may also be partially directed in the tangential direction A, for example at a given tilt angle in relation to the tangential direction at any point circumferentially around the cage body.

As further shown, each rib portion 5 comprises at least one repeating section of the undulating structure 7, i.e. at least one ridge and one groove, between respective tangential rolling-element-contacting edge portions 5a and 5b, which e.g. allows for improved structural stability of the rib-portion as well as improved capacity to store lubrication due to the increase of the rib-portion surface are.

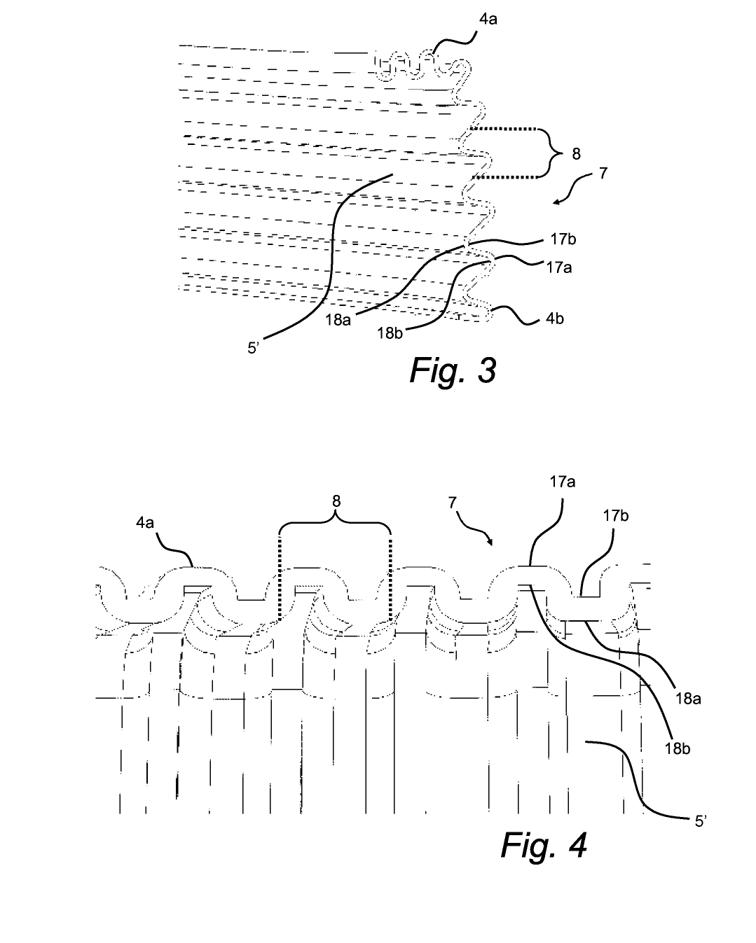

With reference to FIG. 3, a zoomed-in cross-sectional view of the undulating structure 7 of the first embodiment of the rolling bearing cage according to the present invention is shown in an un-finished state, i.e. prior to provision of the openings forming the windows and rib portions. As illustrated, the cage body comprises a circular first rim portion 4a comprising a wavelike structure of ridges and grooves forming part of the undulating structure 7. The cage body further comprises a circular second rim portion 4b also comprising a wavelike structure of ridges and grooves forming part of the undulating structure 7. Furthermore, the unfinished cage body comprises an undulating portion 5′ extending between the first and second rim portions 4a and 4b, which undulating portion 5′ forms the rib portions of the finished cage body. As e.g. illustrated on the undulating structure 7 of the undulating portion 5′, the undulating structure has a wavelike shape comprising a plurality of the consecutively repeating sections indicated by 8. The undulating structure 7 is integrally formed in the one-piece material of which the cage body is formed, and comprises a plurality of repeating sections corresponding to repeating section 8, wherein each section comprises a plurality of inner points corresponding to a groove and a plurality of outer points corresponding to ridges.

In more detail, in FIG. 3, the cross-section of the undulating structure 7 comprises on a radially outer surface a plurality of outer points 17a, forming apexes of ridges of the undulating structure, and a plurality of inner points 17b, forming lowest points of the grooves of the undulating structure. Furthermore, on a radially inner surface of undulating structure, a plurality of corresponding inner points 18b, corresponding to outer points 17a, and outer points 18a, corresponding to inner points 17a, are provided, which points form part of the ridges and grooves of the undulating structure on the radially inner surface.

With reference to FIG. 4, a zoomed-in view of the undulating structure 7 of the second embodiment of the rolling bearing cage according to the present invention is shown in an un-finished state, i.e. prior to provision of the openings forming the windows and rib portions. As illustrated, the cage body comprises a circular first rim portion 4a comprising a wavelike structure forming part of the undulating structure 7. Furthermore, the unfinished cage body comprises a undulating portion 5′ extending from the first rim portions 4a towards the second rim portion 4b (not shown), which undulating portion 5′ forms the rib portions of the finished cage body.

As e.g. illustrated on the undulating structure 7 of the first rim portion 4a, the undulating structure 7 has a wavelike shape comprising a plurality of the consecutively repeating sections as indicated by 8. As further shown, the undulating structure 7 is integrally formed in the one-piece sheet material of which the cage body is formed, and comprises a plurality of repeating sections corresponding to repeating section 8, wherein each section comprises a plurality of inner and outer points.

In more detail, in FIG. 4, the cross-section of the undulating structure 7 comprises on an outer surface a plurality of outer points 17a, forming apexes of the ridges of the undulating structure, and a plurality of inner points 17b, forming lowest points of the grooves of the undulating structure. Furthermore, on an inner surface of undulating structure 7 of the cage body, a plurality of corresponding inner points 18b, corresponding to outer points 17a, and outer points 18a, corresponding to inner points 17a, are provided, which points form part of the ridges and grooves of the undulating structure on the inner surface.

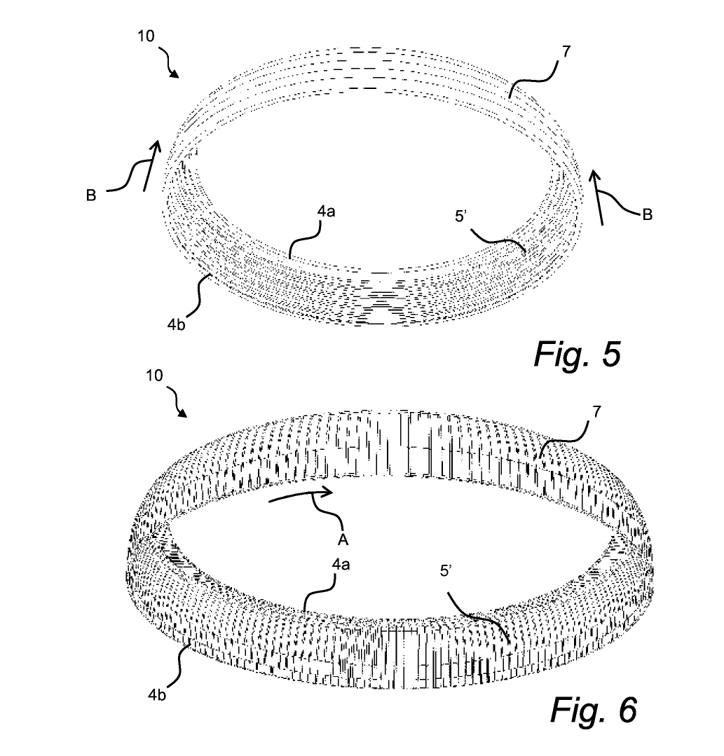

In FIG. 5, a schematic perspective view of the first embodiment of the rolling bearing cage 10 according to the present invention is shown in an un-finished state, prior to the provision of windows for receiving and controlling the position of the rolling elements. In a similar manner, in FIG. 6, a schematic perspective view of the second embodiment of the rolling bearing cage 10 according to the present invention is shown in an un-finished state, prior to the provision of windows for receiving and controlling the position of the rolling elements. As illustrated, the orientation of the undulating structure 7 in FIG. 5 is directed in an axial and a radially inwardly tilted direction, as indicated by arrows B. In FIG. 6, the orientation of the undulating structure is directed in the tangential direction of the cage 10, as indicated by arrow A.

As further shown in FIG. 5 and FIG. 6, circumferentially around the cage 10, the cross-section of the cages 10 is tilted radially inward along the axial direction from the second rim portion 4b towards the first rim portion 4a. Thereby, the shape of the cage, in particular the undulating portion 5′, is adapted to correspond to the internal space of an intended rolling bearing, and is adapted to a curved rolling element shape of the rolling elements in the intended rolling bearing.

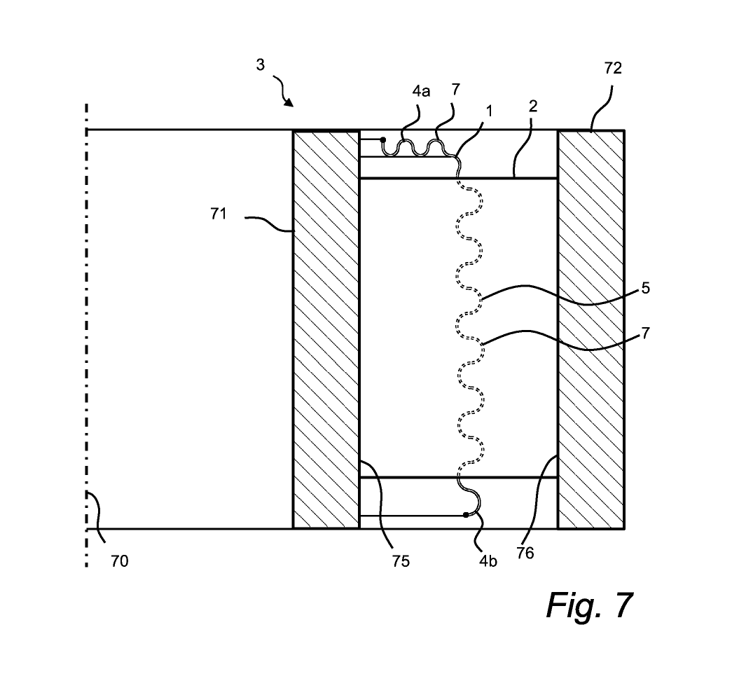

With reference to FIG. 7, a schematic cross-sectional view of an exemplifying third embodiment of the rolling bearing cage 1 according to the present invention is shown, wherein the rolling bearing cage is mounted in a rolling bearing 3 having a center axis 70. The rolling bearing 3 comprises an inner ring 71 provided with an inner raceway 75, an outer ring 72 provided with an outer raceway 76, and a plurality of rolling elements 2 formed of cylindrical rollers arranged in an intermediate configuration between the inner and outer raceways 75 and 76.

As further shown, the rolling bearing 3 is arranged with the light weight rolling bearing cage 1 which is arranged between the inner and outer rings 71 and 72 to cooperate with the rollers 2. The rolling bearing cage is formed of a single piece of worked sheet metal which has been provided with an undulating structure 7. The undulating structure 7 extends on and from a first rim portion 4a in between the rolling elements 2 on and along the rib portion 5 of the cage body. The extension of the undulating structure 7 further extends to and on the second rim portion 4b. During operation, the more light weight and undulated rolling bearing cage 1 ensures correct relative positioning of the rolling elements 2 in relation to each other in an improved manner in relation to known solutions. The undulating structure 7 increases the structural stability of the cage 1 and also increases the surface area of the rib portions 5 as well as the first and second rim portions which results in an increased area for holding and storing lubricant, both axially outside side the rolling element 5 and between the rolling elements. Also, due to the undulating structure 5, the contacting area of the rib portion 5 which is in contact with a raceway-contacting surface of the rolling element 2 is increase allowing for a reduced wear of the cage body. As shown, the rib portion 5, corresponding to the portion of the cage body extending along the extension of the rolling element 2 along its rotational axis, comprises a plurality of repeating sections 8 in a corresponding manner as described and illustrated in relation to FIG. 3. For example, according to various embodiments, the rib portion 5 comprises more than four (4) repeating sections 8, or more than ten (10) repeating sections 8, along the extension of the rolling element along its rotational axis in the rolling bearing 3.

According to various embodiments of the invention, the cage body may be formed in manufacturing processes involving pressure turning, or metal spinning, or flow forming of a sheet metal workpiece, such as a thin sheet metal disc, or in a manufacturing process involving roll forming techniques wherein a sheet-formed workpiece is passed through and formed by sets of rollers.

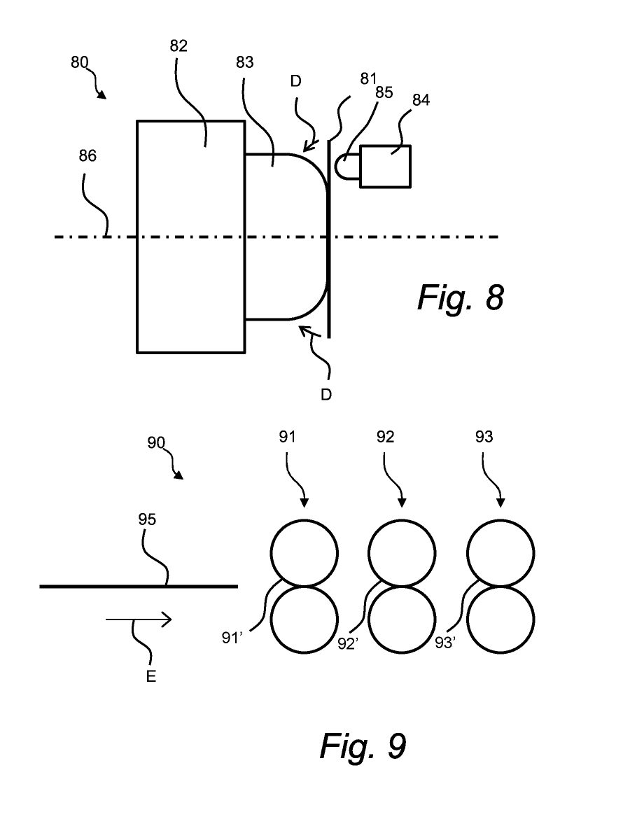

With reference to FIG. 8, a schematic exemplifying flow forming arrangement 80 for manufacturing the cage body of the rolling bearing cage is shown. The arrangement 80 may for example form part of an automated manufacturing line including computer numerical controlled (CNC) operation. As shown, the arrangement 80 comprises a spindle frame unit 82 arranged to rotate a form 83 and disc-shaped workpiece 81 around rotational axis 86 in relation to a motion controlled tool turret 84 comprising a tool 85. During forming, the tool 85 is placed on the rotating workpiece 81 and exerts compressive forces on the workpiece leading to material flow in the metal such that the workpiece conforms with the form 83, as indicated by arrows D. Alternatively, the form 83 may be omitted, wherein the workpiece is formed between the tool 85 and an opposing second tool arranged on a second independent motion controlled tool turret, wherein the two tools forms a pressing tool and a supporting tool arranged on respective sides of the workpiece 81 in relation to the rotational axis 86.

The disc-shaped workpiece may further comprise an axial center opening forming the axial center opening of the finished rolling bearing cage.

The undulating structure is provided during the flow forming process, for example by a corresponding undulating structure provided in the form 83 and roller surface of the tool 85, by a corresponding undulating structure provided in the roller surface of the two opposing cooperating tools, or by the movement pattern of the two opposing cooperating tools during computer numerical controlled operation, or by combinations of above alternatives.

With reference to FIG. 9, a schematic exemplifying roll forming arrangement 90 for manufacturing the cage body of the rolling bearing cage is shown. The arrangement 90 may for example form part of an automated manufacturing line including computer numerical controlled (CNC) operation. As shown, the arrangement 90 comprises a first, second and final set of rollers 91, 92 and 93 each comprising respective first, second and final contacting surfaces 91′, 92′ and 93′ for bending a workpiece 95 while being transferred through the sets of rollers 91, 92 and 93, as indicted by arrow E. As shown, the workpiece 95 is formed of a cut piece of flat metal, but may also be formed of continuous metal strip arranged on a roll of metal being continuously transferred through forming process of the rollers.

As shown, each roller set may comprise two cooperating opposing rollers arranged to receive the workpiece between respective contacting surfaces. Optionally or alternatively, each roller set may comprise a roller and non-rotating support surface, wherein the workpiece is passed between and formed by the contacting surface of the roller and the support surface. The roller may further be arranged to provide the workpiece 95 with a circular shape, wherein longitudinal end portions of the workpiece are connected, e.g. by welding, to form the cage body.

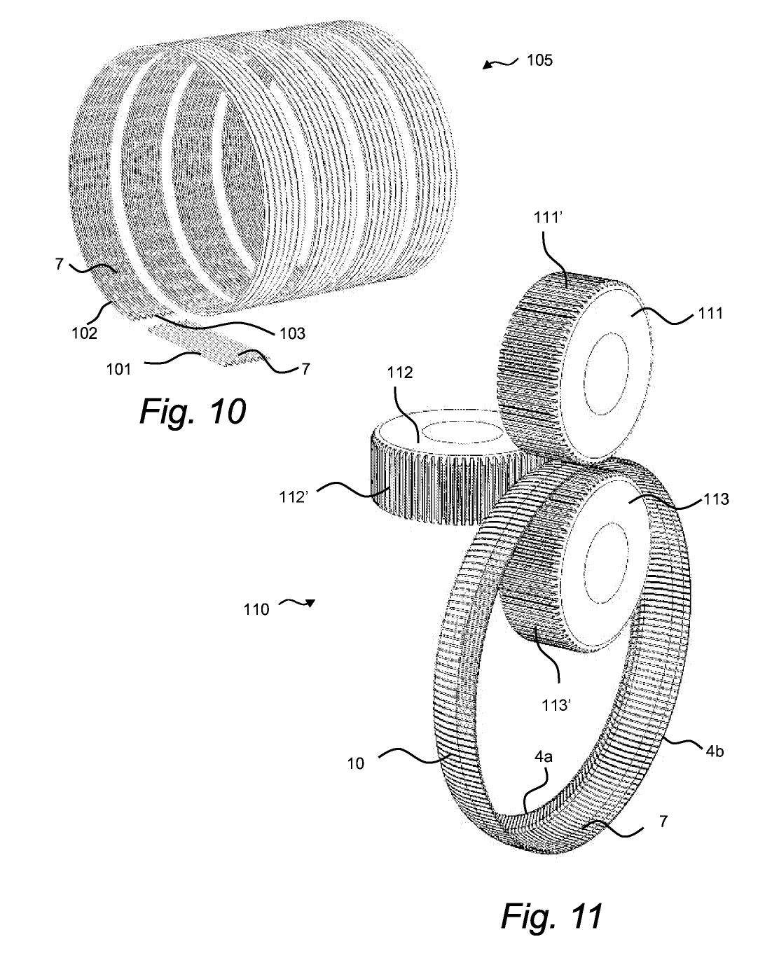

With reference to FIG. 10, schematic perspective views of workpieces 101 and 102 for forming the cage body of embodiments of the rolling bearing cage according to the present invention are shown. Workpiece 101 is formed of a cut metal strip which have been provided with undulating structure 7 by roll forming, for example by a roll forming arrangement as described in FIG. 9. Workpiece 101 is flat and may be provided with a circular shape in a later manufacturing step during which the workpiece is bent. Workpiece 102 is formed of a continuous metal strip, suitably provided from a roll of metal, which have been provided with undulating structure 7 by roll forming, for example by a roll forming arrangement as described in FIG. 9. As shown, after, or in combination with, the provision of the undulating structure 7 the workpiece 102 has been bent into a spiral. Single cages are formed by cutting circular portions corresponding to a complete circle from the spiral and axially aligning and connecting the tangential edge portions 103.

With reference to FIG. 11, a schematic exemplifying roll forming arrangement 110 for manufacturing the cage body of an embodiment of the rolling bearing cage is shown. A first, second and third roller 111, 112 and 113 are provided, each comprising a respective contacting surfaces 111′, 112′ and 113′ for providing an undulating structure 7 in a workpiece 10 while being transferred through the set of rollers 111, 112 and 113. The contacting surfaces 111′, 112′ and 113′ comprise ridges and grooves arranged to imprint, by pressing, a corresponding undulating structure in the workpiece. Mounting and/or dismount the workpiece 10 in relation to the rollers 111, 112 and 113 may involve separating the rollers from each other. Furthermore, the workpiece 10 may be provided with a desired cross-sectional profile by bending action of the rollers 111, 112 and 113 during the forming operation wherein the workpiece 95 is rotated by the rollers. The workpiece may also be provided with a desired cross-sectional profile in prior manufacturing step, e.g. by a punch and dye pressing, deep drawing, or flow forming, e.g. by a flow forming arrangement as described with reference to FIG. 8.

It should be noted that the invention has mainly been described above with reference to a few embodiments. However, as is readily appreciated by a person skilled in the art, other embodiments than the ones disclosed above are equally possible within the scope of the invention, as defined by the appended patent claims.

It is further noted that, in the claims, the word “comprising” does not exclude other elements or steps, and the indefinite article “a” or “an” does not exclude a plurality. A single apparatus or other unit may fulfill the functions of several items recited in the claims. The mere fact that certain features or method steps are recited in mutually different dependent claims does not indicate that a combination of these features or steps cannot be used to an advantage.

1. A rolling bearing cage for controlling the position of rolling elements between an inner and an outer raceway in a rolling bearing, comprising:
a cage body having;
a circular first rim portion,
a plurality of rib portions extending from the first rim portion in a circumferentially spaced apart configuration in relation to each other, and
a plurality of windows formed between adjacent spaced apart rib portions for receiving and controlling the position of the rolling elements, wherein
the first rim portion and the plurality of rib portions of the cage body is formed of a one-piece sheet material and is provided with an undulating structure.

2. The rolling bearing cage according to claim 1, wherein the undulating structure has a wavelike shape having a plurality of consecutively repeating sections.

3. The rolling bearing cage according to claim 1, further comprising a circular second rim portion being coaxial with the first rim portion, wherein each one of the plurality of rib portions extends from the first rim portion to the second rim portion.

4. The rolling bearing cage according to claim 3, wherein the undulating structure extends across a portion of the first rim portion (4a), across the each one of the plurality of rib portions (5), and across a portion of the second rim portion (4b).

5. The rolling bearing cage according to claim 1, wherein the undulating structure extends circumferentially around the cage in a tangential direction (A) of the circular first rim portion.

6. The rolling bearing cage according to claim 1, wherein the undulating structure extends circumferentially around the cage in an axial and/or radial direction (B) of the circular first rim portion.

7. The rolling bearing cage according to claim 1, wherein the undulating structure of the cage body is uniform.

8. The rolling bearing cage according to claim 1, wherein the sheet material is formed of sheet metal.

9. The rolling bearing cage according to claim 8, wherein the undulating structure is integrally formed in the sheet metal.

10. The rolling bearing cage according to claim 1, wherein the period length of the undulating structure is 1-50% of the longitudinal length extension of the rib portions.

11. A method for manufacturing a rolling bearing cage for controlling the position of rolling elements in a rolling bearing, comprising:
forming a cage body having a first circular rim portion and a plurality of rib portions extending from the first rim portion in a circumferentially spaced apart configuration in relation to each other, such that a plurality of windows for receiving the rolling elements are formed between adjacent spaced apart rib portions,
forming the first rim portion and the plurality of rib portions of the cage body from a workpiece formed of a sheet material, and
providing the first rim portion and the plurality of rib portions of the cage body with an undulating structure.

12. The method according to claim 11, further comprising forming a circular second rim portion of the cage body being coaxial with the first rim portion, and providing the second rim portion with the undulating structure.

13. The method according to claim 11, wherein the steps of forming the cage body and providing the undulating structure include rotating the workpiece and forming the workpiece with a first tool by exerting the first tool on the rotating workpiece according to a predetermined pattern.

14. The method according to claim 11, wherein the steps of forming the cage body and providing the undulating structure include passing the workpiece against at least one roller arranged to provide the workpiece with the undulating structure.

15. The method according to claim 11, wherein the windows in the cage body are formed by providing circumferentially spaced apart openings in the workpiece.
